(19) United States
(12) Patent Application Publication
(10) Pub. No.: US 2010/0169383 A1
(43) Pub. Date: Jul. 1, 2010

(54) METHOD FOR DIGITALLY RECORDING INFORMATION

(76) Inventor: Keat Jin Lee, Guilford, CT (US)

Correspondence Address: MICHAUD-Kinney Group LLP, 306 INDUSTRIAL PARK ROAD, SUITE 206, MIDDLETOWN, CT, 06457, US

(21) Appl. No.: 12/718,102

(22) Filed: Mar. 5, 2010

Related U.S. Application Data
(63) Continuation-in-part of application No. 12/326,434, filed on Dec. 2, 2008.

(51) Int. Cl. G06F 3/048; G06F 17/21; G06F 17/30

(52) U.S. Cl. 707/802; 715/810; 715/268; 715/784; 707/E17.044

(57) ABSTRACT

In a computer implemented method for digitally recording progress notes a content database cooperable with software can be populated with information relevant to patients and care providers. A User can select items displayed on a screen of a communications device. The software operates to generate information mandated by one or more certifying authorities by causing questions pertaining to the mandated information and selectable answers to the questions to be displayed on the screen. At least a portion of the questions displayed are dependant on the answers chosen by the user during operation of the communications device. The selected information is received into the content database.

### CROSS REFERENCE

This application is related to and claims the benefit of U.S. patent application Ser. No. 12/326,434 entitled “Method for Digitally Recording Progress Notes” filed on Dec. 2, 2008 and is incorporated by reference herein in its entirety.

### FIELD OF THE INVENTION

The present invention is generally related to a method digitally capturing information and is more specifically directed to a computer implemented method for recording information mandated by a certifying body.

### BACKGROUND

During the course of a medical interview and/or examination, one or more health care providers generally record a significant amount of information. This record is generally referred to as “Progress Notes” or “History and Physical.” Typically this is accomplished via handwritten notes which must later be transcribed by administrative personnel (e.g. a secretary or medical transcriptionist). This involves time, extra cost and provides for the introduction of human error. Moreover, having to handwrite notes requires the health care provider to spend time that could otherwise be spent with a patient, it also requires the health care provider to carry and return paper files. In addition, following the interview and/or examination, the health care provider often sends a letter to a patient, insurance company or to another health care provider (e.g. a referral letter). These letters have historically been written, typed, or dictated. In the case of handwritten or dictated letters, they must then be transcribed and forwarded to the appropriate recipient. All of this adds to the cost and expense associated with the patient's visit. Moreover, there is currently no uniform, standard method for taking and recording patient information.

Electronic Medical Record (EMR) systems have recently become subject to certification by government recognized certifying authorities. In order for an EMR system to qualify for certification, it should be functional to provide certain information as directed by the certifying organization and/or the government. Depending on the type and specialty of the health care provider that a patient is seeing, the information required to be entered into the EMR system may be unrelated to the particular specialty.

For example, a patient may be seeing a podiatrist and the information required to be entered in order for the EMR system to be certified may relate to whether the patient wears glasses. Having to enter such unrelated information is time consuming and therefore reduces either the time a health care provider sees a patient, or the number of patients the health care provider can see. This in turn reduces the profitability of the provider's practice and increases the amount of time that a patient must wait to see the health care provider.

### SUMMARY OF THE INVENTION

The present invention resides in one aspect in a computer implemented method for digitally recording progress notes. The method comprises establishing a content database cooperable with software, the content database being populable with identifying information relevant to particular patients and care providers. The software is customizable by a user such that the user can input items to be displayed on a screen of a communications device. The items are choosable by the user. The software is further customizable to display, on the screen, questions to be answered and the allowable answers to the questions. The questions and selectable answers can be input by a user so that the software is operable to display them in accordance with choices made by the same or another user during an interview and/or examination. The software is operable to allow the user to enter text to be input into a form letter, the text to be input into the form letter being dependant, at least in part, on the allowable answers chosen by a user. The text to be input can be customized and be made dependant on the answers input into the communications device in response to the questions displayed thereon. The software can also be operable with the content database to allow a user to manually enter progress notes.

The present invention also resides in a computer implemented method for quickly and efficiently, within an electronic medical record system, entering information required by an EMR certifying authority related to individual patients. The information required by the certifying authority is programmed into a communication device so that the information can be displayed thereon. During a patient interview wherein the above-described information is being entered by a health care provider or by the patient (hereinafter referred to as the “user”) the user selects a category displayed in the communication device, such as, for example, general information. The user is then presented with one or more selectable items, such as, but not limited to, “Does the patient smoke,” or “has the patient recently lost weight.” Choosing one of these items then results in additional selectable items being displayed by the communication device. These additional items present the user with choices to select from based on answers elicited from the patient. For example, in response to selecting, “Does the patient smoke” the user could be presented with selectable item indicating a “yes” or “no” response. If “no” is selected then the user can move on to the next category of information, such as, for example, “has the patient recently lost weight.” If the item indicating “yes” is selected then another series of selectable items indicative of a patient's response may be displayed. For example, selectable items indicating the number of packs of cigarettes a patient smokes per day may be displayed. Once selected the information corresponding to the selected item will be stored in the patient's medical records. The software can also provide for a user being able to add notes to further describe or clarify a selection. These notes can be typed into the communication device, written by hand such as would be done using an electronic tablet, or tablet-type P.C. The notes may also be recorded into the communication device.

Where the communication device in a tablet or tablet-type P.C., a scrolling feature is integrated into the programming to allow the selectable information to be scrolled through quickly using a system, touch pad, or a user's finger.

### DETAILED DESCRIPTION OF THE PREFERRED EMBODIMENTS

The present invention is directed to a computer implemented method for digitally recording progress notes when evaluating different situations. The method will be described in connection with a health care provider, such as a doctor or a nurse, creating progress notes during a patient interview or examination. However, the present invention is not limited in this regard as utility can be found in other areas, such as for example, an engineering project, or quality control setting. In addition, this method can be a stand-alone application, part of another program or it can be an add-on to an existing program.

During a patient interview, the health care provider using a communications device, such as, a computer, personal digital assistant (PDA), tablet, or the like, can choose from a variety of specialties appearing on the display forming part of the communications device. For example, the health care provider may in the course of an interview or examination, wish to evaluate a patient's ears and/or hearing. As such, the health care provider chooses the appropriate item. These items may include such things as “No Ear Symptoms,” and “No Ear Symptoms Except.” Choosing no ear symptoms would end the evaluation of the patient's ears. However, selecting “No Symptoms Except” leads the health care provider to a menu of symptoms from which the health care provider can choose “yes” or “no” for each symptom. For example, with respect to a patient's ears, the list of symptoms to choose from can include, hearing loss, dizziness, blocked, pain, itch, and drainage. Choosing “no” to any one of these symptoms would end further inquiry with respect to that symptom. This could cause the particular symptom to be removed from the display. Choosing “yes” with respect to the particular symptom results in the user having to answer one or more questions regarding that symptom. The answers the user can choose from will appear as selectable items on the display.

Assuming for sake of description, one of the symptoms the patient exhibits is hearing loss. Choosing the hearing loss item can cause yet another menu of choices to appear on the display of the communications device. For example, the health care provider can choose an item on the communications device display that corresponds to hearing loss being in the right ear, the left ear, or both ears. This choice then can lead to another series of choices such as the duration of the symptoms, the severity of the symptoms, etc. The process of each choice leading to the ability to select from another series of choices can continue until such time as the symptom has been sufficiently explored.

During the above-described process, the software is operable to allow the health care provider to digitally record progress notes. These progress notes can take the form of one or more of typed text, in the case of a tablet and some PDA's that can accommodate it, written text, ink technology, video recordings, audio recordings, and combinations thereof. The software can also be operable to provide for any handwritten notes to be translated into typed text or stored as handwritten notes via digital-ink technology. As used herein, the term digital-ink technology should be broadly construed to refer to technology that digitally represents handwriting in its natural form. In general, in a typical digital-ink system, a digitizer is laid over a liquid crystal display (LCD) screen to create an electromagnetic field that can capture the movement of a stylus and record the movement on an LCD screen. The recorded handwriting can be saved as handwriting or converted to type written text if handwriting recognition technology is employed.

The above-described computer implemented method has thus far been described in connection with a patient interview. Similarly, once an interview has been conducted, an examination may follow. As with the patient interview, the health care provider can use the communications device operable with the software to memorialize the findings made during the examination. As the examination progresses, or subsequent thereto, the health care provider can enter the findings. For example, referring again to an ear examination, the health care provider during the course of the examination can initially be presented with a series of choices. Choosing the appropriate item corresponding to the findings made can result in the health care provider being presented with another series of choices. As with the above-described patient interview, the health care provider can continue to be presented with choices until such time as the examination is concluded.

During the above-described process, the software is operable to allow the health care provider to digitally record progress notes. These progress notes can take the form of one or more of typed text, in the case of a tablet type computer having a tablet screen and some PDA's that can accommodate it, written text, ink technology, video recordings, audio recordings, and combinations thereof. The software can also be operable to provide for any handwritten notes to be translated into typed text or stored as handwritten notes via digital-ink technology.

Once the interview is finished and/or the examination concluded, the health care provider can enter a disposition. Depending on the findings made, or the results of the interview, the disposition can take one of several forms. For example, a referral to a specialist may be necessary, certain tests or therapies may be required, medication may be needed, and/or follow-up visits. Again, the software is operable with the communications device to allow for the entry of typed, in some instances handwritten, and/or recorded (audio and/or video) progress notes.

Prior to a patient interview and/or examination, the software can be operable to cause patient identifying information to be associated with the information recorded by the health care provider. The digital progress notes, the software, and patient data can be stored on a server, or other computer with the communications device having software sufficient thereon to allow for access to the software on the server or other computer as well as to the database.

The server can be resident within, for example, an office and be accessible over an intranet, or the server can be remotely located and be accessible over using a virtual private network or similar type of connection. The software application can also be web-based and employ the internet to provide access thereto. Access can be attained via a website accessible using the communications device.

Once the interview and/or examination has been concluded and a disposition decided upon, the health care provider can use the communications device to automatically generate one or more form-type letters that incorporate all or a portion of the information ascertained during the interview and/or examination. For example, if it is determined that the patient needs to be referred to a specialist, a referral letter can be generated. The health care provider can select the type of letter to be created and then can select from a predetermined list, or type the entity's name to which the referral is being made. The digital progress notes can be part of the referral. The type of letter generated will also determine which information from the digital progress notes should be included. The letters can be e-mailed from the communications device, printed, faxed, and sent to secretarial personnel for printing and mailing, or combinations thereof.

In the above-described examples, the software can be customizable by the user/health care provider. For example, the health care provider can enter the items that are accessible during an interview and/or examination, and can also enter the questions to be answered depending on the choices made by the user of the communications device. The user or other personnel can also determine the answers from which the user of the communications device can choose.

The above-described form letters can also be customized by the user or other person to input predetermined text depending on the choices made by the user of the communications device in answering the questions presented thereby. Accordingly, a user can create diagnostic symptoms lists and related questions as well as predetermined text to be input into form letters generated as a result of the responses to the choices made from the symptoms lists and related questions. Where necessary, the progress notes input by the user of the communications device can also be part of the form letters. This option can be given to the user at the time of generating the form letter.

The software, because of the manner by which a user can determine what is displayed on the screen of the communications device, can be easily modified or the questions and/or symptoms list updated as new information becomes available. In this manner a medical or other type of office can be run consistently and with dramatically improved efficiencies.

The present invention also resides in a computer implemented method for quickly and efficiently, within an electronic medical record system, entering information required by an EMR certifying authority related to individual patients. The information required by the certifying authority is programmed into a communication device so that the information can be displayed thereon. During a patient interview wherein the above-described information is being entered by a health care provider or by the patient (hereinafter referred to as the “user”) the user selects a category displayed in the communication device, such as, for example, general information. The user is then presented with one or more selectable items, such as, but not limited to, “Does the patient smoke,” or “has the patient recently lost weight.” Choosing one of these items then results in additional selectable items being displayed by the communication device. Then additional items present the user with choices to select from based on answers elicited from the patient. For example, in response to selecting, “Does the patient smoke” the user could be presented with selectable item indicating a “yes” or “no” response. If “no” is selected then the user can move on to the next category of information, such as, for example, “has the patient recently lost weight.” If the item indicating “yes” is selected then another series of selectable items indicative of a patient's response may be displayed. For example, selectable items indicating the number of packs of cigarettes a patient smokes per day may be displayed. Once selected the information corresponding to the selected item will be stored in the patient's medical records. The software can also provide for a user being able to add notes to further describe or clarify a selection. These notes can be typed into the communication device, written by hand such as would be done using an electronic tablet, or tablet-type P.C. The notes may also be recorded into the communication device.

Where the communication device in a tablet or tablet-type P.C., a scrolling feature is integrated into the programming to allow the selectable information to be scrolled through quickly using a system, touch pad, or a user's finger.

The exemplary information referred to above should not be considered an exhaustive listing as there are a myriad of different information types that can be required by the certifying authority. The digital decision tree described above allows the user to very rapidly input acquired information thereby allowing for more time to be spent by the health care provider with the patient.

Although this invention has been shown and described with respect to the detailed embodiments thereof, it will be understood by those of skill in the art that various changes may be made and equivalents may be substituted for elements and steps thereof without departing from the scope of the invention. In addition, modifications may be made to adapt a particular situation to the teachings of the invention without departing from the essential scope thereof. Therefore, it is intended that the invention not be limited to the particular embodiments disclosed in the above detailed description, but that the invention will include all embodiments falling within the scope of the above description.

What is claimed is:

1. A computer implemented method for digitally recording progress notes, the method comprising:
establishing a content database cooperable with software, said content database being populable with identifying information relevant to patients and care providers;
said software being operable by a user such that said user can select items displayed on a screen forming a part of a communications device;
said software being operable to generate information mandated by one or more certifying authorities by causing questions pertaining to said mandated information and selectable answers to said questions to be displayed on said screen, at least a portion of said questions displayed being dependant on said answers chosen by a user during operation of said communications device; and
receiving said selected information into said content database.

2. A method as defined by claim 1 wherein said communications device is one of a desktop computer, a laptop computer, a tablet computer, and a PDA.

3. A method as defined by claim 1 wherein said software is operable with said content database to allow a user to manually enter notes into said communications device.

4. A method as defined by claim 3 wherein said communications device includes a tablet screen and said tablet screen and said software are operable such that via digital-ink technology a user can handwrite said notes onto said tablet screen.

5. A method as defined by claim 4 wherein said notes are stored in said content database as handwriting.

6. A method as defined by claim 5 wherein said software is operable to convert said notes into typed text.

7. A method as defined by claim 1 wherein said software is operable to allow a user to quickly scroll through information shown on said display.
